(19) United States
(12) Patent Application Publication
(10) Pub. No.: US 2014/0095885 A1
(43) Pub. Date: Apr. 3, 2014

(54) METHODS FOR BIOMETRIC REGISTRATION AND VERIFICATION, AND RELATED SYSTEMS AND DEVICES

(71) Applicants: Julien Bringer, Issy-Les-Moulineaux (FR); Stéphane Gaillebotte, Issy-Les-Moulineaux (FR); Francois Rieul, Issy-Les-Moulineaux (FR); Hervé Chabanne, Issy-Les-Moulineaux (FR)

(72) Inventors: Julien Bringer, Issy-Les-Moulineaux (FR); Stéphane Gaillebotte, Issy-Les-Moulineaux (FR); Francois Rieul, Issy-Les-Moulineaux (FR); Hervé Chabanne, Issy-Les-Moulineaux (FR)

(73) Assignee: MORPHO, Issy-Les-Moulineaux (FR)

(21) Appl. No.: 14/115,615

(22) PCT Filed: Feb. 16, 2012
(86) PCT No.: PCT/FR2012/050333

§ 371 Date: Nov. 4, 2013

(30) Foreign Application Priority Data
May 6, 2011 (FR) 1153911

(51) Int. Cl. H04L 9/08

(52) U.S. Cl. CPC H04L 9/0866
USPC 713/186

(57) ABSTRACT

The invention relates to a registration method for future biometric verification purposes, including the following steps for one person (I): obtaining first biometric data (4) and second biometric data (5) relating to said person; obtaining alphanumerical data (a) including at least one identifier relating to said person; storing, in a first biometric database (1), the thus-obtained first biometric data in association with a decryption key (6); storing, in a correspondence table (T), first information from the thus-obtained second biometric data and alphanumerical data in correspondence with an index (j); storing, in a second database (2), second information from the thus-obtained second biometric data and alphanumerical data in association with a version (J) of said index that is encrypted with an encryption key corresponding to said decryption key, said second information being different from the first information.

The invention concerns biometric enrollment and verification.

Biometric verification traditionally refers to the authentication or identification of individuals, human or animal, based on biometric data concerning characteristics of one or more biological attributes of these individuals, such as the minutiae of fingerprints, the general shape of the fingers, the veins of a hand or finger, voice characteristics, iris characteristics, etc.

Such biometric verification conventionally uses a database in which biometric data are stored. These data concern individuals having previously undergone an enrollment phase so that they can be granted a certain right after biometric verification (driver's license delivery, ticket for mass transit, remuneration, authorization to access a room, etc.).

A very simple example of biometric verification is illustrated in FIG. 1, which shows a database 1 storing a set of biometric data b₁, b₂, . . . , b_{N} concerning enrolled individuals.

These biometric data b₁, b₂, . . . , b_{N} are, for example, images representing some biological attribute for each of the respective individuals (for example images of fingerprints, irises, etc.), characteristics relative to a biological attribute (for example a type, position, and orientation of minutiae in the case of fingerprints), or some other data.

Advantageously, a digital representation of the biometric data can be used in order to simplify manipulation and render these data usable in a cryptographic algorithm.

As a non-limiting example, the biometric data b₁, b₂, . . . , b_{N} stored in the database 1 may each consist of a numeric vector, for example a binary vector. Numerous ways of obtaining a numeric vector from biometric information are known.

In the example in FIG. 1, the biometric verification occurs in the following manner for a given individual. Biometric data b′ is obtained, for example in digital vector form, for the individual considered. This data b′ is compared to some or all of the data b₁, b₂, . . . , b_{N} stored in the database 1 (reference 2).

In case of a match or sufficient similarity thereto, one can infer that the individual concerned corresponds to an enrolled individual (identification) or to the enrolled individual he or she is claiming to be (authentication). This result is labeled R in FIG. 1.

The biometric database 1 is sometimes linked to a database of individuals' identities (for example in alphanumeric form). Such is the case with an authentication, for deciding whether or not an individual is the enrolled individual he or she is claiming to be.

A one-to-one relationship between the biometric data and identity data stored in these databases could allow the owner of these databases to find the connection between these two types of data too easily. This constitutes a problem when said owner is not a trusted person, or when constraints, such as legal constraints, prohibit such a situation. In addition, a dishonest person, other than the owner of the database, who manages to access said databases could make use of this connection between the two types of data to steal the identity of enrolled individuals.

It is possible to protect the biometric and/or identity data using a cryptographic algorithm, in order to make this task more difficult for a dishonest person. Aside from the fact that this adds complexity to the biometric verification, it does not protect the data from the owner of the databases because it is generally the owner who controls the cryptographic algorithm and who holds the keys.

It has also been proposed to use a “weak link” between a biometric database 1 and an identity database. Such a weak link does not allow establishing a one-to-one correspondence between biometric data and identity data, but still allows searching for an individual at an acceptable rate of success.

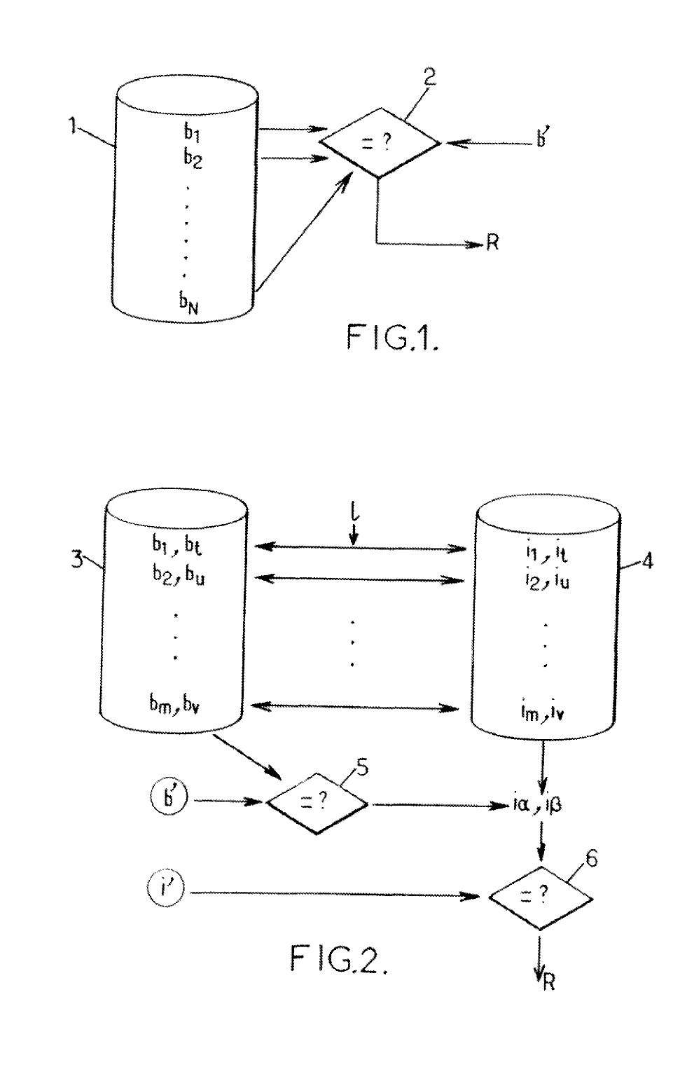

An example diagram of a weak link is provided in FIG. 2. The biometric database 3 stores groups of biometric data concerning different individuals. In the example illustrated, these groups consist of two elements, although a larger number of elements is possible and is even recommended. Similarly, the identity database 4 stores groups of identity data concerning different individuals; there are two data items in the example in FIG. 2, although a larger number of elements is again quite possible. The number of groups and/or elements per group may possibly differ between the biometric database 3 and the identity database 4.

The link l (lower case “l”) between the two databases 3 and 4 maps to each group of biometric data, for example (b₁,bₜ), a respective group of identity data, for example (i₁,iₜ).

A person having access to the databases 3 and 4, including their owner, cannot discover the correspondence between a biometric data item and an identity data item with certainty and without additional investigation (he can only discover it between two groups).

Biometric verification remains possible, however. As illustrated in FIG. 2, if an individual with a biometric characteristic b′ and an identity i′ presents himself for authentication for example, the presence of b′ in the biometric database 3 is verified (step 5), then the group of identity data (i_{α},i_{β}) corresponding to the group of biometric data to which b′ belongs is found using the weak link l. A result R can then be deduced from a comparison between i′ and the elements of the group (i_{α},i_{β}). If i′ corresponds to data among the identity data i_{α} or i_{β}, it can be concluded for example that the individual is indeed the person he claims to be.

The use of such a weak link therefore improves the situation. But the problem returns when multiple biometric and/or identity databases are used in relation to the same individuals, for example in several independent applications. In this case, an intersection between the groups of biometric and/or identity data can make it possible to discover a correspondence between certain biometric data and identity data.

More generally, a link, even a weak one, between a biometric database and an identity database represents a weak point in the protection of privacy.

One aim of the invention is to limit at least some of the disadvantages of the prior art techniques described above.

The invention therefore proposes an enrollment method for future biometric verification purposes, comprising the following steps relative to an individual:
obtaining first biometric data and second biometric data relating to said individual;
obtaining alphanumeric data including at least one identifier relating to said individual;
storing the obtained first biometric data, in a first biometric database, in association with a decryption key;
storing, in a mapping table, first information from among the obtained second biometric data and the obtained alphanumeric data, in correspondence with an index;
storing, in a second database, second information from among the obtained second biometric data and the obtained alphanumeric data, in association with a version of said index that is encrypted with an encryption key corresponding to said decryption key, said second information being different from the first information.

Such an enrollment makes use of additional biometric data (the second biometric data) unlike the prior art techniques discussed above. This additional biometric data allows organizing a link between the first biometric data and the alphanumeric data.

In addition, this link is protected in a particularly effective manner, because of the supplemental use of an index system and an encryption/decryption mechanism for this index.

One will note that the scheme described above can be extended to the use of more than two databases and/or more than one mapping table, with the use of more than two biometric data items and/or more than one alphanumeric data item, while remaining within the scope of the invention.

One will also note that, still within the scope of the invention, the data can be distributed among the databases and mapping table(s) according to any conceivable distribution scheme that allows verifying the link between the three types of data in the desired manner. The following description involves a specific example distribution of the three types of data, but it would also be possible to reverse the decryption key and the unencrypted index in the databases/tables, and/or the encrypted index and the decryption key, and/or the various biometric and alphanumeric data, etc. All these combinations are considered as being equivalent and are covered by the invention.

In advantageous characteristics which can be combined in any conceivable manner:
the second biometric data is traceless biometric data; and/or
the mapping table initially stores pieces of synthetic information of the same type as said first information, each corresponding to an index, and the storing of said first information corresponding to said index comprises the replacing of the synthetic information initially stored in correspondence to said index by said information; and/or
the same mechanism can be implemented by initially filling the first database and/or second database with synthetic data, which complicates the problem and increases the protection of privacy;
said first information is stored in the mapping table in association with at least one piece of synthesized information of the same type as said first information; and/or
said index is only used in the mapping table and in the second database in relation to the first information and second information relating to said individual; and/or
said index is used in the mapping table and/or in the second database in relation to information relating to multiple individuals.

The invention additionally proposes a system or device (the device being the special case of the system, grouping all the functions in one single structure) for implementing an enrollment as mentioned above, comprising, relative to an individual:
a unit for obtaining first biometric data relating to said individual;
a unit for obtaining second biometric data relating to said individual;
a unit for obtaining alphanumeric data including at least one identifier relating to said individual;
a first biometric database for storing the first biometric data, in association with a decryption key;
a mapping table for storing first information, from among the second biometric data and the alphanumeric data, with a corresponding index;
a second database for storing second information, from among the obtained second biometric data and the obtained alphanumeric data, in association with a version of said index encrypted with an encryption key corresponding to said decryption key, said second information being different from the first information.

The invention also proposes a biometric identification method making use of a first biometric database, a second database, and a mapping table which are supplied with data during the course of an enrollment method as mentioned above. This biometric identification method comprises the following steps relative to an individual:
obtaining first biometric data relating to said individual;
obtaining first information, from among second biometric data relating to said individual and alphanumeric data including at least one identifier relating to said individual;
searching for a decryption key stored in the first biometric database in association with biometric data corresponding to the obtained first biometric data;
searching for an index corresponding to information stored in the mapping table, said information corresponding to the obtained first information;
finding in the second database, when a decryption key and an index searched for in this manner have been found, second information stored in association with a version of said index encrypted with an encryption key corresponding to said decryption key.

The last step above may, for example, consist of performing a possibly exhaustive scan of the second database to find a version of said index encrypted with an encryption key corresponding to said decryption key.

The invention also proposes a biometric authentication method making use of a first biometric database, a second database, and a mapping table which are supplied with data in the course of an enrollment method as mentioned above. This biometric authentication method comprises the following steps relative to an individual:
obtaining first biometric data relating to said individual;
obtaining first information, from among second biometric data relating to said individual and alphanumeric data including at least one identifier relating to said individual;
obtaining second information, from among said second biometric data relating to said individual and said alphanumeric data, said second information being different from the first information;
searching for a decryption key stored in the first biometric database in association with biometric data corresponding to the obtained first biometric data;
searching for an index corresponding to information stored in the mapping table, said information corresponding to the obtained first information;
searching for an encrypted index stored in the second database in association with information corresponding to the obtained second information;
when a decryption key, index, and encrypted index searched for in this manner have been found, verifying whether the encrypted index corresponds to a version of said index encrypted with an encryption key corresponding to said decryption key.

The invention further proposes a system or device (the device being a special case of the system, grouping all the functions in one single structure) for implementing a biometric identification making use of a first biometric database, a second database, and a mapping table which are supplied with data during the course of an enrollment method as mentioned above. This system or device comprises, relative to an individual:
a unit for obtaining first biometric data relating to said individual;
a unit for obtaining first information, from among second biometric data relating to said individual and alphanumeric data including at least one identifier relating to said individual;
a unit for searching for a decryption key stored in the first biometric database in association with biometric data corresponding to the obtained first biometric data;
a unit for searching for an index corresponding to information stored in the mapping table, said information corresponding to the obtained first information;
a unit for finding in the second database, when a decryption key and an index have been found, second information stored in association with a version of said index encrypted with an encryption key corresponding to said decryption key.

The invention also proposes a system or device (the device being a special case of the system, grouping all the functions in one single structure) for implementing a biometric authentication making use of a first biometric database, a second database, and a mapping table which are supplied with data during the course of an enrollment method as mentioned above. This system or device comprises, relative to an individual:
a unit for obtaining first biometric data relating to said individual;
a unit for obtaining first information, from among second biometric data relating to said individual and alphanumeric data including at least one identifier relating to said individual;
a unit for obtaining second information, from among said second biometric data relating to said individual and said alphanumeric data, said second information being different from the first information;
a unit for searching for a decryption key stored in the first biometric database in association with biometric data corresponding to the obtained first biometric data;
a unit for searching for an index corresponding to information stored in the mapping table, said information corresponding to the obtained first information;
a unit for searching for an encrypted index stored in the second database in association with information corresponding to the obtained second information;
a unit for verifying, when a decryption key, index, and encrypted index have been found, whether the encrypted index corresponds to a version of said index encrypted with an encryption key corresponding to said decryption key.

The invention further proposes a computer program product comprising instruction code for implementing the enrollment method and/or the biometric identification method and/or the biometric authentication method mentioned above, when it is loaded into and executed by computer means.

Other features and advantages of the invention will become apparent from the following description of some non-limiting examples, with reference to the accompanying drawings in which:

FIG. 1, already discussed, is a diagram illustrating a simple example of biometric verification according to the prior art;

FIG. 2, already discussed, is a diagram illustrating another simple example of biometric verification according to the prior art;

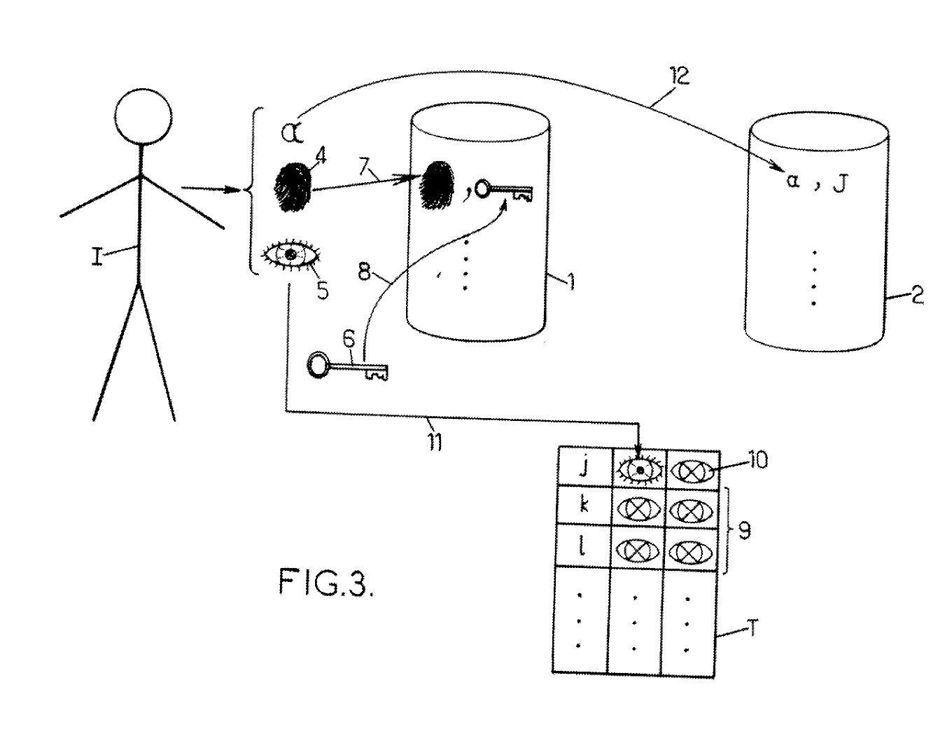

FIG. 3 is a diagram illustrating an example of enrollment in a non-limiting embodiment of the invention;

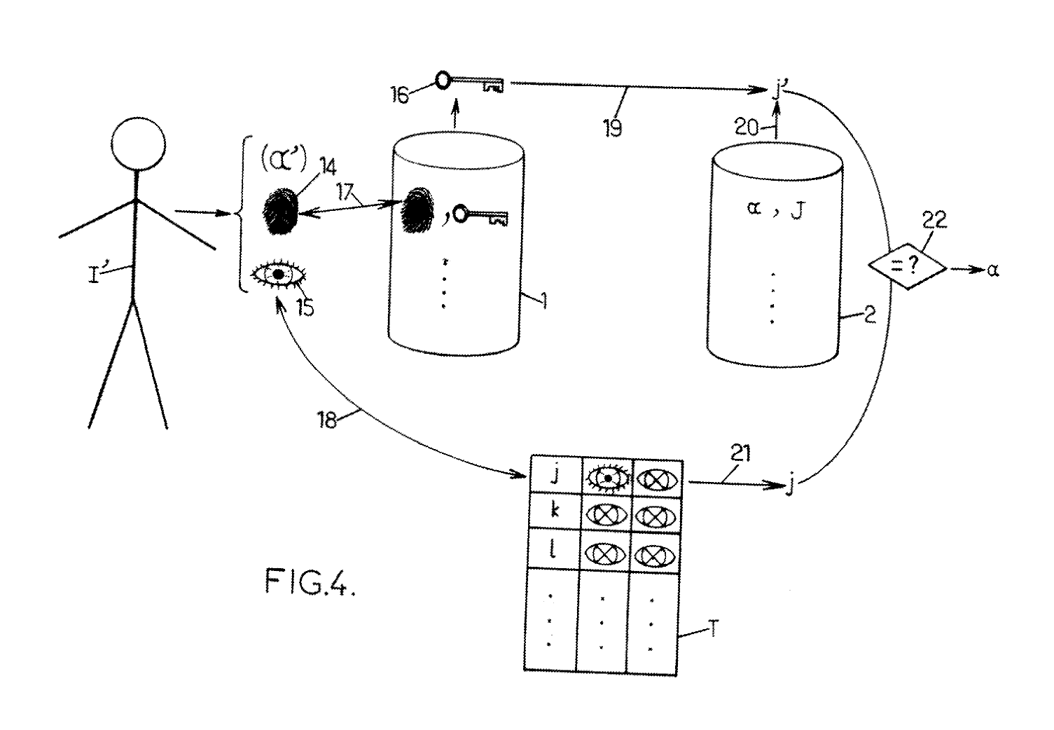

FIG. 4 is a diagram illustrating an example of biometric verification in a non-limiting embodiment of the invention.

FIG. 3 illustrates an example of enrollment in one aspect of the invention. Here it concerns the enrollment of an individual I (capital letter “i”), it being understood that the same type of enrollment can be performed for a plurality of individuals.

In the context of an enrollment, three data items concerning the individual I in question are obtained. These are the first biometric data 4, second biometric data 5, and alphanumeric data α.

In the example illustrated in FIG. 3, the first biometric data 4 concerns a fingerprint of the individual I, possibly in a digital representation. The second biometric data 5 concerns characteristics of an iris of the individual I, possibly in a digital representation.

It is of course understood that the biometric data 4 and 5 could be of any conceivable type (face, general shape of the fingers, veins of a hand or a finger, voice characteristics, etc.). The biometric data 4 and 5 are advantageously of different types. In addition, it can be advantageous to have the biometric data 5 involve a biometric characteristic that is traceless or that leaves very little trace after the individual has left, as is the case with the iris (but also the veins, voice signature, etc.). Additionally or alternatively, it can be advantageous if the biometric data 5 concerns a biometric characteristic not used in official documents.

The means of obtaining biometric data 4 and 5 are adapted to the type of biometric data. For example, it could be a fingerprint capturing unit for biometric data 4 and an iris capturing unit for biometric data 5, possibly supplemented with modules for processing the captured data in order to provide them in the desired format. As a variant, the biometric data 4 and/or 5 could be obtained without a new capture, but from existing official documents (paper or electronic), for example a passport which already contains biometric data for the individual I. Other examples can also be considered, as will be apparent to a person skilled in the art.

As for the alphanumeric data α, these include an identifier relative to the individual I. This identifier can, for example, include or consist of an identity of the individual I, or other types of information concerning the individual. As an example, the alphanumeric data a can include some or all of the following information concerning the individual I: last name, first name, date of birth, social security number, and/or other information. Additionally or alternatively, it may include place of residence information, financial information, and/or other information.

The alphanumeric data a may be in diverse formats and obtained in various ways. The alphanumeric data may, for example, result from concatenating various alphabetic and/or numeric information concerning the individual I. But it may also come from more elaborate processing, for example such as generating a condensed version of various alphabetic and/or numeric information concerning the individual I, e.g. using a hash function or other processing.

There are various possible means for obtaining the alphanumeric data α. They may be entirely manual, entirely automated, or semi-automated. They may, for example, include consulting existing official documents (paper or electronic), for example a passport which already contains identity information for the individual I. Other examples are also possible, as will be apparent to a person skilled in the art.

For simplicity, the following description will use the terms fingerprint 4, iris 5, and identifier α to refer to the first biometric data 4, the second biometric data 5, and the alphanumeric data α respectively. This is not to be interpreted as a limitation on the generality of the invention.

In step 7, the obtained fingerprint 4 is then stored in a biometric database 1 intended for receiving fingerprints (or possibly other types of biometric data) for all the enrolled individuals. The fingerprint 4 is stored in association with a decryption key 6, as indicated by the reference 8.

The decryption key 6 is a cryptographic key of any type and of any conceivable form. It can be associated with any type of known decryption algorithm. It additionally corresponds to a cryptographic encryption key, meaning that it is capable of decrypting data encrypted with the corresponding encryption key. In other words, the two cryptographic keys, encryption and decryption, are linked. The decryption key 6 can be the same as the corresponding encryption key (symmetric encryption) or different (asymmetric encryption), as will be apparent to a person skilled in the art.

The decryption key 6 can be generated specifically for the individual I and not used for any other enrolled individual. Alternatively, it could be reused for some or all of the enrolled individuals. For example, the decryption key 6 may be generated by the owner of the database 1 or by some other entity.

In step 11, the iris 5 is stored in a mapping table T, with a corresponding index j. There are various possible formats and types of mapping table T, as will be apparent to a person skilled in the art. For example, the index j can be stored as a field in the mapping table T, and so can the iris 5, as represented in FIG. 3. In another example, the index j could be deduced directly, for example from the row number where the iris 5 is stored in the mapping table T. The index j may, for example, consist of a numeric value, for example a positive integer, or may be in any other conceivable form as will be apparent to a person skilled in the art.

Advantageously, before being supplied with data during an enrollment, the mapping table T initially stores synthetic information of the same type as the iris 5. This synthetic information 9 concerns representations of fake irises (meaning irises not corresponding to actual enrolled individuals). They are each stored in a manner that gives them a corresponding index k, l, . . . . This storage can be done randomly.

When the enrollment of individual I occurs, the iris 5 is then stored in the mapping table T by replacing one of the synthetic data items with this iris 5, which in this case is one of those initially stored as corresponding to index j. The true iris 5 can, for example, randomly replace any synthetic iris stored in the mapping table T and is thus assigned the index j which corresponded to this synthetic iris.

Such use of synthetic information creates noise, which complicates the task of a dishonest person who manages to gain access to the content of the mapping table T and wants to retrieve relevant information about the enrolled individuals. Without this measure, such dishonest persons could easily detect the irises of all the first individuals enrolled.

Additionally or alternatively, a mechanism of the same type can be utilized in relation to database 1 and/or database 2. In other words, one and/or the other of these databases can initially be filled with synthetic data. This complicates the task facing a dishonest person and increases the protection of privacy.

The synthetic information 9, such as the iris 5, could be iris images. It seems preferable, however, to use encoded irises (“iriscodes”), which are digital representation of the iris. In fact, it seems that encoded irises based on synthetic iris images, for example, are difficult or even impossible to differentiate from encoded real irises. The encoded synthetic irises thus appear more likely to fool a dishonest person than images of fake irises. This further complicates the task facing a dishonest person.

Additionally or alternatively, the mapping table T can store multiple pieces of information corresponding to a given index. As a non-limiting example, one or more synthetic irises 10 can be stored which correspond to index j, alongside the iris 5 of the individual I, as illustrated in FIG. 3. This is yet another optional measure, intended to complicate the task facing a dishonest person by adding horizontal noise.

In step 12, the identifier α for individual I is stored in a second database 2. It is stored there in association with a version J of index j, encrypted with an encryption key corresponding to the decryption key 6.

One will note that the various steps illustrated in FIG. 3 can be implemented in any conceivable order.

Some or all of the data mentioned above can be stored unencrypted or encrypted, with the advantages and disadvantages inherent to each of these solutions.

It is therefore understood that after the steps described above, the mapping table T establishes a link between the fingerprint 4 and the identifier α respectively stored in databases 1 and 2. This link is based on a second biometric data item, in this case the iris 5. The use of such a second biometric data item is particularly simple, because it involves information that the individual I always has on his or her person, without necessarily knowing the details.

This link is also based on the use of an index which acts as a pointer between the mapping table T and the database 2. This index provides additional misdirection to further complicate decisions by an unauthorized person.

This link is further protected by an encryption/decryption mechanism (the index is accessible unencrypted in the mapping table T, but only in the encrypted version in database 2, encrypted with an encryption key for which the corresponding decryption key 6 is stored only in database 1), which further complicates the existing relationship between the three data items 4, 5 and α.

It is possible for the index j to be used in the mapping table T and in database 2 (in its encrypted form J) only in relation with the iris 5 and the identifier α for the one individual I. This is a strong link, meaning that the index j then assures, in combination with the decryption key 6 and the iris 5, a one-to-one relation between the fingerprint 4 and the identifier α.

As a variant, the same index j can be used in the mapping table T and in the database 2 (in its encrypted form J) in relation to the iris and the identifier of one or more individuals, in addition to individual I. This is then a weak link, where even a knowledge of the index j and the decryption key 6 associated with the individual I does not allow certain discovery, without further investigation, of the relation between the three data items 4, 5 and α concerning the individual I.

In the following description, the fingerprint 4, the iris 5, and the identifier α are respectively stored in the (biometric) database 1, the mapping table T, and the (alphanumeric) database 2. However, any other conceivable distribution of these data between databases 1 and 2 and the mapping table T can alternatively be used within the scope of the invention. As an example, the fingerprint 4, the identifier α, and the iris 5 could be stored in the (biometric) database 1, the mapping table T, and the (biometric) database 2 respectively, using the same general principles as described above, as will be apparent to a person skilled in the art. In this particular case, for example, if synthetic information is used in the mapping table T, as was discussed above, this will then involve alphanumeric data including fictitious identifiers.

Below it will be assumed that databases 1 and 2 as well as the mapping table T were supplied with data during the course of an enrollment method as described above. This enrollment could concern only one individual I or a plurality of individuals.

FIG. 4 illustrates an example of biometric verification which makes use of databases 1 and 2 and a mapping table T that have been supplied with data in this manner.

It concerns the case of a biometric verification (meaning an identification and/or authentication) related to an individual I′, who may be the same as individual I or may be another individual.

A first biometric data item 14, a second biometric data item 15, and optionally an alphanumeric data item α′ are obtained concerning this individual I′. More generally, any pair among the three data items 14, 15 and α′ could be obtained. These data are identical or similar in type to the data 4, 5 and α mentioned above in relation to individual I. The means of obtaining them may also be identical or similar to what was described above in the context of enrolling individual I.

Again for reasons of simplicity, the case of a fingerprint 14, an iris 15, and an identifier α′ is considered below, but this is not to be interpreted as a limitation on the generality of the invention.

Step 17 searches for a decryption key stored in the biometric database 1 in association with a fingerprint corresponding to the fingerprint 14 of individual I′.

For example, this search may consist of scanning some or all of the fingerprints stored in the biometric database 1, and comparing each of them to the fingerprint 14. This comparison can make use of any appropriate method, such as calculating a Hamming distance, comparing the minutiae, or some other method, as will be apparent to a person skilled in the art.

If there is a match or sufficient similarity between the fingerprint 14 and a fingerprint stored in database 1, the decryption key 16 stored in association with this fingerprint can then be found. When the individual I′ is the same as the enrolled individual I, the decryption key 16 found is normally the same as the decryption key 6 mentioned above.

Step 18 searches for a mapping index corresponding to an iris, corresponding to the iris 15 of individual I′, stored in the mapping table T.

For example, this search can consist of scanning some or all of the irises stored in the mapping table T, and comparing each one to the iris 15. This comparison can make use of any appropriate method, such as calculating a Hamming distance or some other method, as will be apparent to a person skilled in the art.

If there is a match or sufficient similarity between the iris 15 and an iris stored in the mapping table T, the corresponding index can then be found. When the individual I′ is the same as the enrolled individual I, the index found is normally the same as the index j mentioned above (step 21).

When a decryption key 16 and an index have been found as described above, then an identifier α is found in the second database 2, stored in association with a version of said index encrypted with an encryption key corresponding to the decryption key 16.

To do this, it is possible for example to decrypt some or all of the encrypted indexes stored in the database 2 using the found decryption key 16 (steps 19 and 20), then to compare the thusly decrypted index j′ with the index found in step 21 in order to detect whether or not there is a match.

Additionally or alternatively, an encryption key corresponding to the found decryption key 16 can be obtained (for example because symmetrical encryption is used in which the encryption and decryption keys are identical, or because the encryption key is known to the owner of database 1 where the decryption key 16 is stored, or for any other conceivable reason). Then the index found in step 21 is encrypted with the obtained encryption key and is compared with one or more encrypted indexes from database 2.

Additionally or alternatively, if one has the identifier α′ of individual I′, database 2 can be searched for the encrypted index which is stored in association with α′. Then it is possible to verify whether this index corresponds to an encrypted version of the index found in step 21.

Advantageously, the indexes and the encryption/decryption mechanism can be defined so that the decryption of any of the encrypted indexes, using any of the decryption keys, still results in a (possibly fake) index value. For example, this can be achieved using a decryption algorithm which always returns an index falling within a certain range of values, each index being associated with real or fake irises. The decryption space of the indexes is covered by the mapping table T, i.e. all possible decryptions that will yield an index must be within the mapping table T in order to have an associated iris (possibly synthetic).

A non-limiting example of an algorithm usable in this context is an El Gamal encryption algorithm which properly satisfies the confidentially requirements of encrypted indexes, because the encryption is then probabilistic (two encryptions of the same index yield two different values). This limits the search to one direction only: the encrypted index must be decrypted in order to establish the link with the index in the mapping table T. In this case, the decryption procedure can be defined as being conventional El Gamal decryption but with a reduction of the result modulo the size of the table T.

This therefore complicates the task facing a dishonest person attempting to differentiate unpromising index values after decryption in order to try to discover identifier information.

In the case where individual I′ is the same as individual I, the index j′ decrypted using decryption key 16 (identical to decryption key 6) must be the same value as the index j found in step 21. The comparison 22 between these two index values therefore reveals a match. Individual I′ is thus successfully identified as an enrolled individual.

The identifier α stored in association with the encrypted version J of j′ can also be found.

It is possible to compare this found identifier α to identifier α′, when the latter has been obtained for biometric verification purposes. This is a case of authentication. This comparison between α and α′ can occur in a final verification step, to validate that individual I′ is indeed the individual I he or she is claiming to be. Additionally or alternatively, it can be conducted beforehand, for example to find the index J stored in association with α, then to compare only this index to the one found in step 21 (possibly with encryption or decryption), which prevents having to scan a large number of indexes of the database 2.

It should be noted that the various steps illustrated in FIG. 4 can be carried out in any conceivable order.

When some or all of the data mentioned above are stored in an encrypted form, appropriate decryption mechanisms are additionally implemented, as will be apparent to a person skilled in the art.

Consistent with the enrollment example described with reference to FIG. 3, here again it is assumed that the fingerprints, irises, and identifiers were stored in database 1, mapping table T, and database 2 respectively. Other configurations are possible, however, as was mentioned above. In such cases, the biometric verification must be adapted appropriately, as will be apparent to a person skilled in the art.

Thus, in the case where the fingerprints, identifiers, and irises are stored in database 1, mapping table T, and database 2 respectively, the biometric verification can be conducted by obtaining the fingerprint 14 of individual I′ and his or her identifier α′, deducing a decryption key 16 and an index by means of database 1 and mapping table T, then finding, in database 2, an iris stored in association with a version of said index encrypted with an encryption key corresponding to said decryption key. This iris may possibly be compared to an iris 15 of individual I′ to make a decision concerning biometric verification.

Other embodiments are conceivable within the scope of the invention, as will be apparent to a person skilled in the art.

The enrollment as described above may be conducted using a system or device comprising units appropriate for this purpose. The same is true for the biometric verification. The systems or devices used for the enrollment and biometric verification may be the same or, conversely, may be different, possibly with certain similar or common parts.

These systems or devices may, for example, each comprise an electronic and/or computerized device comprising a data processing module, possibly associated with a biometric capture terminal.

Some or all of the enrollment and/or biometric verification operations mentioned above can be carried out using a computer program comprising appropriate instructions, when it is loaded onto and executed by computer means.

1. Enrollment method for future biometric verification purposes, comprising the following steps relative to an individual:
obtaining first biometric data and second biometric data relating to said individual;
obtaining alphanumeric data including at least one identifier relating to said individual;
storing the obtained first biometric data, in a first biometric database, in association with a decryption key;
storing, in a mapping table, first information from among the obtained second biometric data and the obtained alphanumeric data, in correspondence with an index;
storing, in a second database, second information from among the obtained second biometric data and the obtained alphanumeric data, in association with a version of said index that is encrypted with an encryption key corresponding to said decryption key, said second information being different from the first information.

2. Method according to claim 1, wherein the second biometric data is traceless biometric data.

3. Method according to claim 1, wherein the mapping table initially stores synthetic information of the same type as said first information, each with a corresponding index, and wherein the storing of said first information with said corresponding index, in the mapping table, comprises the replacing of the synthetic information initially stored in correspondence to said index by said first information.

4. Method according to claim 1, wherein said first information is stored in the mapping table in association with at least one piece of synthetic information of the same type as said first information.

5. Method according to claim 1, wherein said index is only used in the mapping table and in the second database in relation to the first information and second information relating to said individual.

6. Method according to claim 1, wherein said index is used in the mapping table and/or in the second database in relation to information relating to multiple individuals.

7. System or device for implementing an enrollment according to any of the above claims, comprising, relative to an individual:
a unit for obtaining first biometric data relating to said individual;
a unit for obtaining second biometric data relating to said individual;
a unit for obtaining alphanumeric data including at least one identifier relating to said individual;
a first biometric database for storing the first biometric data, in association with a decryption key;
a mapping table for storing first information, from among the second biometric data and the alphanumeric data, with a corresponding index;
a second database for storing second information, from among the obtained second biometric data and the obtained alphanumeric data, in association with a version of said index encrypted with an encryption key corresponding to said decryption key, said second information being different from the first information.

8. Biometric identification method making use of a first biometric database, a second database, and a mapping table which are supplied with data during the course of an enrollment method according to claim 1, said biometric identification method comprising the following steps relative to an individual:
obtaining first biometric data relating to said individual;
obtaining first information, from among second biometric data relating to said individual and alphanumeric data including at least one identifier relating to said individual;
searching for a decryption key stored in the first biometric database in association with biometric data corresponding to the obtained first biometric data;
searching for an index corresponding to information stored in the mapping table, said information corresponding to the obtained first information;
finding in the second database, when a decryption key and an index searched for in this manner have been found, second information stored in association with a version of said index encrypted with an encryption key corresponding to said decryption key.

9. Biometric authentication method making use of a first biometric database, a second database, and a mapping table which are supplied with data in the course of an enrollment method according to claim 1, said biometric authentication method comprising the following steps relative to an individual:
obtaining first biometric data relating to said individual;
obtaining first information, from among second biometric data relating to said individual and alphanumeric data including at least one identifier relating to said individual;
obtaining second information, from among said second biometric data relating to said individual and said alphanumeric data, said second information being different from the first information;
searching for a decryption key stored in the first biometric database in association with biometric data corresponding to the obtained first biometric data;
searching for an index corresponding to information stored in the mapping table, said information corresponding to the obtained first information;
searching for an encrypted index stored in the second database in association with information corresponding to the obtained second information;
when a decryption key, index, and encrypted index searched for in this manner have been found, verifying whether the encrypted index corresponds to a version of said index encrypted with an encryption key corresponding to said decryption key.

10. System or device for implementing a biometric identification making use of a first biometric database, a second database, and a mapping table which are supplied with data during the course of an enrollment method according to claim 1, the system or device comprising, relative to an individual:
a unit for obtaining first biometric data relating to said individual;
a unit for obtaining first information, from among second biometric data relating to said individual and from alphanumeric data including at least one identifier relating to said individual;
a unit for searching for a decryption key stored in the first biometric database in association with biometric data corresponding to the obtained first biometric data;
a unit for searching for an index corresponding to information stored in the mapping table, said information corresponding to the obtained first information;
a unit for finding in the second database, when a decryption key and an index have been found, second information stored in association with a version of said index encrypted with an encryption key corresponding to said decryption key.

11. System or device for implementing a biometric authentication making use of a first biometric database, a second database, and a mapping table which are supplied with data during the course of an enrollment method according to claim 1, the system or device comprising, relative to an individual:
a unit for obtaining first biometric data relating to said individual;
a unit for obtaining first information, from among second biometric data relating to said individual and alphanumeric data including at least one identifier relating to said individual;
a unit for obtaining second information, from among said second biometric data relating to said individual and said alphanumeric data, said second information being different from the first information;
a unit for searching for a decryption key stored in the first biometric database in association with biometric data corresponding to the obtained first biometric data;
a unit for searching for an index corresponding to information stored in the mapping table, said information corresponding to the obtained first information;
a unit for searching for an encrypted index stored in the second database in association with information corresponding to the obtained second information;
a unit for verifying, when a decryption key, index, and encrypted index have been found, whether the encrypted index corresponds to a version of said index encrypted with an encryption key corresponding to said decryption key.

12. (canceled)
